(19) United States
(12) Patent Application Publication
(10) Pub. No.: US 2015/0163322 A1
(43) Pub. Date: Jun. 11, 2015

(54) Method for acquiring information of client terminal, server and computer-readable medium

(71) Applicant: TENCENT TECHNOLOGY (SHENZHEN) COMPANY LIMITED, Shenzhen (CN)

(72) Inventor: Shaojia Xie, Shenzhen (CN)

(21) Appl. No.: 14/622,138

(22) Filed: Feb. 13, 2015

Related U.S. Application Data
(63) Continuation of application No. PCT/CN2013/083266, filed on Sep. 11, 2013.

(30) Foreign Application Priority Data
Sep. 24, 2012 (CN) 201210356577.7

(51) Int. Cl. H04L 29/08

(52) U.S. Cl. CPC H04L 67/306; H04L 67/10

(57) ABSTRACT

The server disclosed in the present disclosure receives a feature identification transmitted by a feature acquisition device, acquires information of a client terminal corresponding to the feature identification according to the feature identification, and transmits the acquired information of the client terminal to the feature acquisition device. The present disclosure can apply feature identification techniques such as a fingerprint sensor to the social life, thus not only facilitating a client terminal (e.g., a user) to exchange personal information rapidly but also avoiding problems such as information loss or record error.

### CROSS REFERENCE TO RELATED APPLICATIONS

This is a continuation application of International Patent Application No.: PCT/CN2013/083266, filed on Sep. 11, 2013, which claims priority to Chinese Patent Application No.: 201210356577.7 filed on Sep. 24, 2012, the disclosure of which is incorporated by reference herein in its entirety.

### TECHNICAL FIELD

The present disclosure relates to the field of Internet techniques, and in particular to a method or acquiring information of a client terminal, a server and a storage medium.

### BACKGROUND

With the growing popularity of electronic devices, a client terminal (e.g., a user) has a growing demand for functions of electronic devices.

With the increasing development of feature identification techniques such as a fingerprint sensor, the feature identification techniques are applied widely to some portable devices. Taking the fingerprint sensor as an example, since fingerprint information of a user acquired by the fingerprint sensor can be served as a unique feature identification of the user, the user can be identified by the fingerprint sensor.

In social life, users often need to exchange their respective personal information, e.g., exchanging their respective business cards or informing orally the other side of their phone numbers, microblog addresses and the like, and then the other side will record manually the above information. The disadvantages of the above way of individual information exchange lie in: business cards are easily lost, thus resulting in a loss of information of the other side, while oral informing has problems such as an input error, thereby bringing great inconvenience to the usage of it by a user.

It is one of the research focuses in the field of Internet techniques to apply feature identification techniques such as a fingerprint sensor to the social life so as to facilitate a user to exchange personal information rapidly and to avoid problems such as information loss or record error.

### SUMMARY

The embodiments of the present disclosure provides a method for acquiring information of a client terminal, to apply feature identification techniques such as a fingerprint sensor to the social life so as to facilitate a user to exchange personal information rapidly and to avoid problems such as information loss or record error.

The method for acquiring information of a client terminal includes:

fingerprint data of the client terminal and information of the client terminal corresponding to the fingerprint data of the client terminal are acquired in advance by a server, the fingerprint data of the client terminal are correlated with the information of the client terminal and they are stored in the server;

fingerprint data of the client terminal transmitted by a feature acquisition device are received by the server, information of the client terminal corresponding to the fingerprint data of the client terminal is acquired according to the fingerprint data of the client terminal; and

acquired information of the client terminal is transmitted by the server to the feature acquisition device.

The embodiments of the present disclosure further provides a method for acquiring information of a client terminal, to apply feature identification techniques such as a fingerprint sensor to the social life so as to facilitate a user to exchange personal information rapidly and to avoid problems such as information loss or record error.

The method for acquiring information of a client terminal includes:

a feature identification of the client terminal transmitted by a feature acquisition device is received by a server;

information of the client terminal corresponding to the feature identification of the client terminal is acquired by the server according to the feature identification of the client terminal; and

acquired information of the client terminal is transmitted by the server to the feature acquisition device. The embodiments of the present disclosure further provides a server, to apply feature identification techniques such as a fingerprint sensor to the social life so as to facilitate a user to exchange personal information rapidly and to avoid problems such as information loss or record error. The server includes:

a feature identification reception module configured to receive a feature identification of a client terminal transmitted by a feature acquisition device;

a client terminal information acquisition module configured to acquire information of the client terminal corresponding to the feature identification of the client terminal according to the feature identification of the client terminal; and

a client terminal information transmission module configured to transmit the information of the client terminal acquired by the client terminal information acquisition module to the feature acquisition device.

The embodiments of the present disclosure further provides a storage medium, to apply feature identification techniques such as a fingerprint sensor to the social life so as to facilitate a user to exchange personal information rapidly and to avoid problems such as information loss or record error.

In the storage medium, a processor-executable instruction is stored, wherein the processor-executable instruction is configured to enable a processor to implement the following operations:

receiving a feature identification of the client terminal transmitted by a feature acquisition device;

acquiring information of the client terminal corresponding to the feature identification according to the feature identification of the client terminal; and

transmitting acquired information of the client terminal to the feature acquisition device.

Compared to the prior art, in the present disclosure, a correlated feature identification of a client terminal and information of the client terminal are stored in advance in a server, after the client terminal inputs the feature identification of the client terminal through a feature acquisition device, the feature acquisition device transmits the feature identification of the client terminal to the server, the server matches the client terminal information corresponding to the feature identification of the client terminal according to the feature identification of the client terminal, and transmits matched client terminal information to the feature acquisition device. It is obvious that the present disclosure can apply feature identification techniques such as a fingerprint sensor to the social life, thus not only facilitating a client terminal (e.g., a user) to exchange personal information rapidly but also avoiding problems such as information loss or record error, thereby facilitating greatly the usage of the client terminal.

In order to make above content of the present disclosure clearer and more understandable, the present disclosure will be elaborated below by illustrating preferable embodiments with reference to the accompanying drawings.

### BRIEF DESCRIPTION OF THE DRAWINGS

FIG. 1 is a schematic diagram of an operation environment of a method for acquiring information of a client terminal according to embodiments of the present disclosure;

FIG. 2 is a schematic flow of a method for acquiring information of a client terminal according to a preferable embodiment of the present disclosure;

FIG. 3 is a schematic flow of a method for acquiring information of a client terminal according to another preferable embodiment of the present disclosure;

FIG. 4 is a schematic structural diagram of a system for acquiring information of a client terminal according to embodiments of the present disclosure; and

FIG. 5 is a schematic structural diagram of a server according to a preferable embodiment of the present disclosure.

### DETAILED DESCRIPTION

Referring to the drawings, wherein same reference numbers stand for same assemblies, the principle of the present disclosure is illustrated by being implemented in a proper computing environment. Below descriptions are based on specific embodiments of the illustrated present disclosure, and the specific embodiments should not be considered as a limitation to other specific embodiments not described herein.

In the following description, unless otherwise stated, the specific embodiments of the present disclosure will be described with reference to steps and their symbols of operations implemented by one or more computer(s)/mobile device(s). Therefore, it will be known that these steps and operations, of which are mentioned several times that they are implemented by a computer/mobile device, include electronic signals, in the form of structured data, manipulated by a processing unit of a computer/mobile device. The manipulation converts the data or maintains the data into positions in a memory system of the computer/mobile device, the manipulation may be reconfigured or change the operation of the computer/mobile device in a way known by those skilled in the art. The data structure maintained by the data is a physical location of the memory, and the physical location has specific features defined by the data format. However, the principle of the present disclosure is explained by the above description, which is not intended to limit the present disclosure, and those skilled in the art will understand that all the various steps and operations may also be implemented in a hardware.

The principle of the present disclosure is operated by using many other general-purposed or specific-purposed computing systems, communication environments or configurations. Examples of well-known computing systems, environments and configurations suitable for embodiments of the present disclosure include, but are not limited to: systems based on a tablet computer, mobile phone, personal computer, server, multi-processor system and microcomputer, main-frame computer, and a distributed computing environment which includes any of the above systems or devices.

The term “module” used herein refers to a software object implemented on the computing system. Here different assemblies, modules, engines and services may be implemented as objects or processes implemented on the computing system. But the system and method described here are preferably implemented as a software, and implementations on a hardware is also possible and is considered.

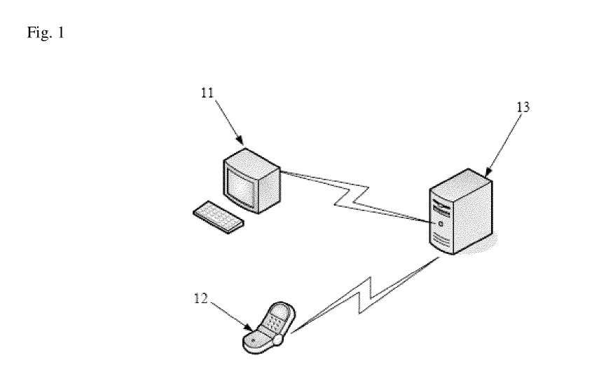

Referring to FIG. 1, FIG. 1 is a schematic diagram of an operation environment of a method for acquiring information of a client terminal according to embodiments of the present disclosure, including: a feature uploading terminal 11, a feature acquisition device 12 and a server 13, wherein both the feature uploading terminal 11 and the feature acquisition device 12 are connected to the server 13 via an internetwork, the server 13 stores in advance a feature identification of a client terminal from the feature uploading terminal 11 and information of the client terminal corresponding to the feature identification of the client terminal, and the feature identification of the client terminal may be for example fingerprint data, retina data and the like. After the feature identification of the client terminal transmitted by the feature acquisition device 12 is received, a matching is performed on pre-stored correlation relation between a feature identification of the client terminal and information of the client terminal, and once the matching succeeds, corresponding information of the client terminal is acquired and transmitted to the feature acquisition device 12.

Wherein the feature uploading terminal 11 or the feature acquisition device 12 may be constituted not only by a desk-top computer but also by a laptop computer, a work station, a palmtop computer, a Ultra Mobile Personal Computer (UMPC), a tablet PC, a Personal Digital Assistant (PDA), a web pad, a portable phone or the like, which is a terminal having computing capability with a storage unit and a microprocessor installed.

The internetwork may include data communication networks including a Local Area Network (LAN), a Metropolitan Area Network (MAN), a Wide Area Network (WAN), the Internet and the like, and may further include telephone networks, wired or wireless and regardless of their communication modes.

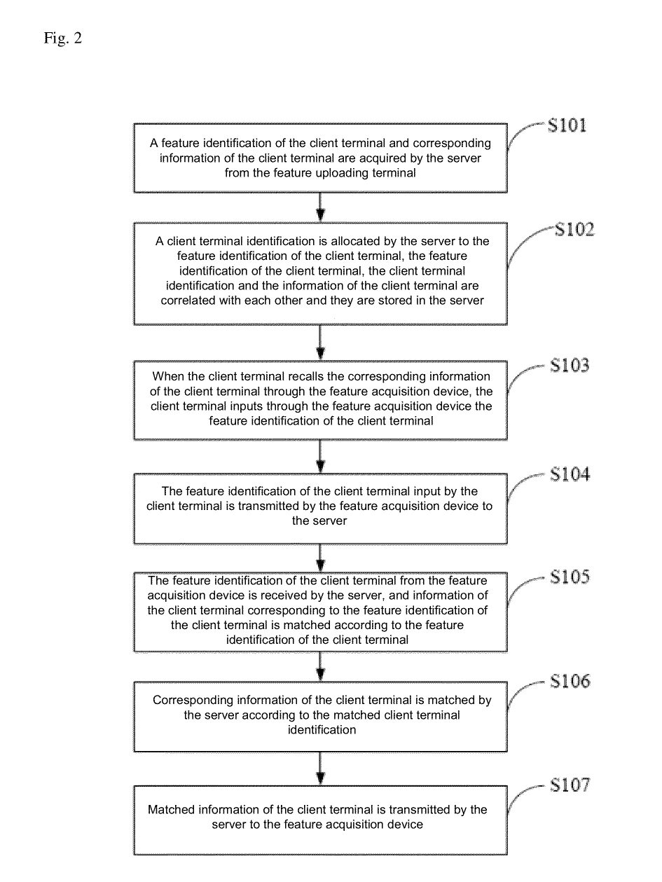

FIG. 2 is a schematic flow of a method for acquiring information of a client terminal according to a preferable embodiment of the present disclosure.

In step S101, a feature identification of the client terminal and corresponding information of the client terminal are acquired by the server 13 from the feature uploading terminal 11.

In a practical implementation process, the client terminal (e.g., a user) may input the feature identification of the client terminal and the corresponding information of the client terminal through the feature uploading terminal 11, and the feature uploading terminal 11 uploads the feature identification of the client terminal and the information of the client terminal input by the client terminal to the server 13.

For example, the client terminal may input the feature identification of the client terminal and the information of the client terminal through a personal computer, laptop computer, mobile phone with a fingerprint sensor, so as to be uploaded to the server 13. The feature identification of the client terminal includes at least one of fingerprint data, palm print data, retina data, voice data and face feature data, and it may also be other forms of feature identifications. While the information of the client terminal may include at least one of a name, telephone number, mail address, blog, sharing or geographic location, and it may also be other information of the client terminal, e.g., place of birth.

In step S102, a client terminal identification is allocated by the server 13 to the feature identification of the client terminal, the feature identification of the client terminal, the client terminal identification and the information of the client terminal are correlated with each other and they are stored in the server.

Wherein both the step S101 and S102 are a step for presetting, i.e., the client terminal implements in advance on a personal computer or other feature uploading terminal the step of uploading a feature identification of the client terminal and information of the client terminal, and the final result is that a correlation relation between the feature identification of the client terminal, the client terminal identification and corresponding information of the client terminal is stored in the server 13.

In step S103, when the client terminal recalls the corresponding information of the client terminal through the feature acquisition device 12, the client terminal inputs through the feature acquisition device 12 the feature identification of the client terminal, e.g., inputting fingerprints.

In step S104, the feature identification of the client terminal input by the client terminal is transmitted by the feature acquisition device 12 to the server 13, for example, after the client terminal inputs fingerprints, corresponding fingerprint data are transmitted to the server 13.

In Step S105, the feature identification of the client terminal from the feature acquisition device 12 is received by the server 13, and a client terminal corresponding to the feature identification of the client terminal is matched according to the feature identification of the client terminal.

In step S106, corresponding information of the client terminal is matched by the server 13 according to a matched client terminal identification.

In step S107, matched information of the client terminal is transmitted by the server 13 to the feature acquisition device 12.

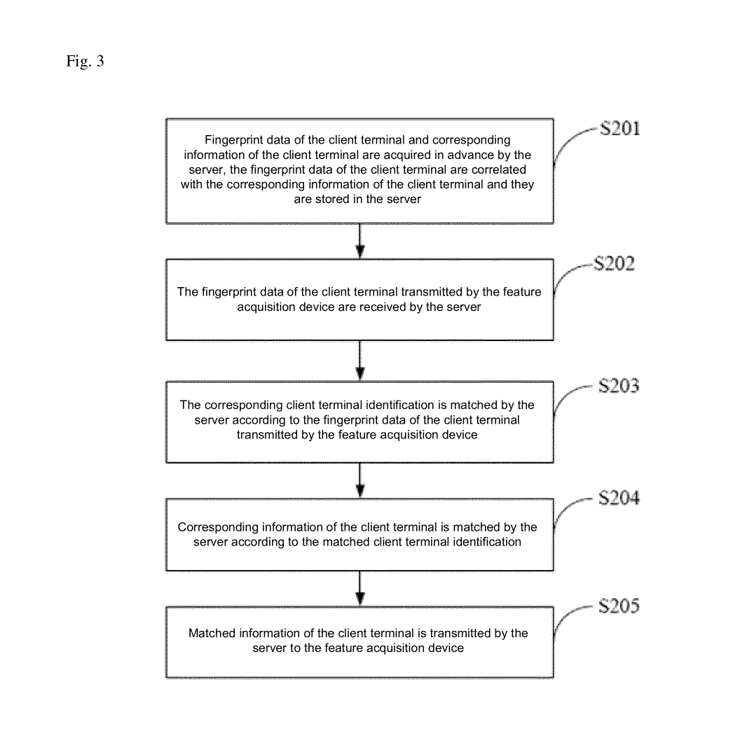

Referring also to FIG. 3, FIG. 3 is a schematic flow diagram of a method for acquiring information of a client terminal according to another preferable embodiment of the present disclosure, in this embodiment, the feature identification of the client terminal is fingerprint data.

In step S201, fingerprint data of the client terminal and corresponding information of the client terminal are acquired in advance by the server 13, the fingerprint data of the client terminal are correlated with the corresponding information of the client terminal and they are stored in the server 13.

Specifically, after the client terminal uploads through the feature uploading terminal 11 the fingerprint data of the client terminal and the information of the client terminal, a client terminal identification is allocated by the server 13 to the fingerprint data of the client terminal, the feature identification of the client terminal, the client terminal identification and the information of the client terminal are correlated with each other and they are stored in the server.

In step S202, the fingerprint data of the client terminal transmitted by the feature acquisition device 12 are received by the server 13.

When the client terminal needs to acquire the information of the client terminal, the fingerprint data of the client terminal can be transmitted by the feature acquisition device 12 to the server 13.

In step S203, the corresponding client terminal identification is matched by the server 13 according to the fingerprint data of the client terminal transmitted by the feature acquisition device 12.

In step S204, corresponding information of the client terminal is matched by the server 13 according to a matched client terminal identification.

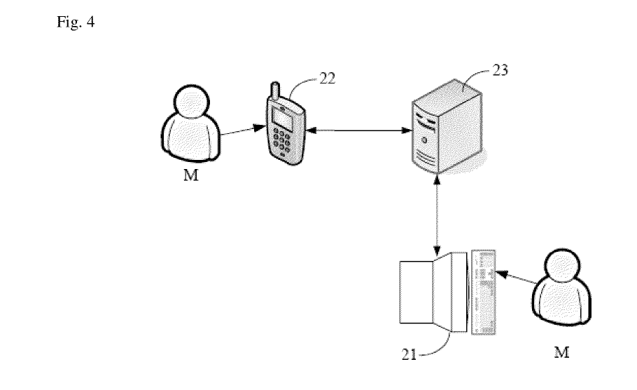

In step S205, matched information of the client terminal is transmitted by the server 13 to the feature acquisition device 12. Referring also to FIG. 4, FIG. 4 is a schematic structural diagram of a system for acquiring information of a client terminal according to a preferable embodiment of the present disclosure, and the operation process of the present disclosure will be described below with reference to FIG. 4.

A client terminal M inputs, in a personal computer 21 with a fingerprint sensor, a fingerprint, a name A of the client terminal, a telephone number 123, a blog address and the like, the personal computer 21 transmits to a server 23 the fingerprint of the client terminal M, the name A of the client terminal, the telephone number 123, the blog address and the like, and the server 23 correlates the the above information and then stores them.

When the client terminal M exchanges information of the client terminal with another client terminal, the client terminal M can input directly a fingerprint on a mobile phone 22 of another client terminal, the mobile phone 22 of another client terminal transmits the fingerprint of the client terminal M to the server 23, the server 23 matches, according to the fingerprint of the client terminal M, to corresponding information such as the name A, telephone number 123, blog address and the like, and transmits the above information back to the mobile phone 22 of another client terminal, at this point the mobile phone 22 of another client terminal can then store related information of the client terminal M. Obviously, the above method not only facilitates the rapid exchange of personal information between the client terminal M and another client terminal, but also avoids problems such as information loss or record error, thereby facilitating greatly the usage of the client terminal.

Certainly, the client terminal M may further input a fingerprint on its own mobile phone to perform login authentication, and the server 23 returns to the mobile phone of the client terminal M a blog address, a sharing and the like of the client terminal M. The client terminal M may further make an online hotel reservation by inputting a fingerprint through a mobile phone with a fingerprint sensor, then input directly the fingerprint on a feature acquisition device of the counter of the hotel so as to implement authentication.

Certainly, the present disclosure may further be used to perform other operations, e.g., pairing of different fingerprints, analyzing personalities by a texture of a fingerprint and the like, which are not enumerated herein.

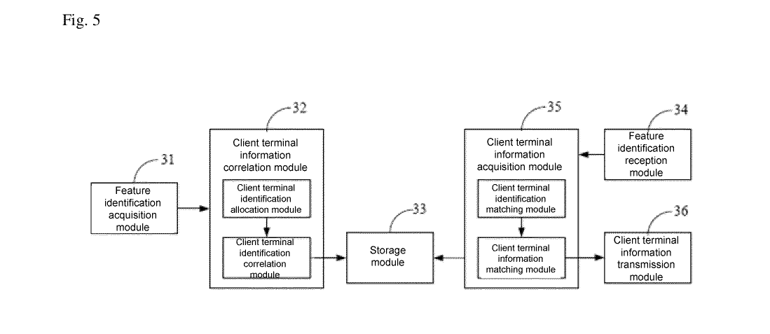

Referring to FIG. 5, FIG. 5 is a schematic structural diagram of a server according to a preferable embodiment of the present disclosure.

The server includes a feature identification acquisition module 31, a client terminal information correlation module 32, a storage module 33, a feature identification reception module 34, a client terminal information acquisition module 35 and a client terminal information transmission module 36.

The feature identification acquisition module 31 is configured to acquire in advance a feature identification of the client terminal; the client terminal information correlation module 32 is configured to correlate the feature identification of the client terminal with information of the client terminal corresponding to the feature identification of the client terminal; and the storage module 33 is configured to store a correlated feature identification of the client terminal and information of the client terminal in the server 13.

The feature identification reception module 34 is configured to receive the feature identification of the client terminal transmitted by the feature acquisition device 12; the client terminal information acquisition module 35 is configured to acquire information of the client terminal corresponding to the feature identification of the client terminal according to the feature identification of the client terminal; and the client terminal information transmission module 36 is configured to transmit the information of the client terminal acquired by the client terminal information acquisition module 35 to the feature acquisition device 12.

The client terminal information correlation module 32 includes a client terminal identification allocation module 321 and a client terminal identification correlation module 322, wherein the client terminal identification allocation module 321 is configured to allocate a client terminal identification corresponding to the feature identification of the client terminal to the feature identification of the client terminal; and the client terminal identification correlation module 322 is configured to correlate the feature identification of the client terminal, the client terminal identification corresponding to the feature identification of the client terminal with the information of the client terminal, and store them in the server 13.

The client terminal information acquisition module 35 includes a client terminal identification matching module 351 and a client terminal information matching module 352, wherein the client terminal identification matching module 351 is configured to match the client terminal identification corresponding to the feature identification of the client terminal according to the feature identification of the client terminal; and the client terminal information matching module 352 is configured to match the information of the client terminal according to a client terminal identification matched by the client terminal identification matching module 351.

The feature identification of the client terminal preferably includes at least one of fingerprint data, palm print data, retina data, voice data and face feature data, and it may also be other forms of feature identifications, and it may also include other forms of feature identifications, all of which are within the scope of protection of the present disclosure and are not enumerated herein.

In the present disclosure, a correlated feature identification of a client terminal and information of the client terminal are stored in advance in a server, after the client terminal inputs the feature identification of the client terminal through a feature acquisition device, the feature acquisition device transmits the feature identification of the client terminal to the server, the server matches corresponding client terminal information according to the feature identification of the client terminal, and returns matched client terminal information to the feature acquisition device. It is obvious that the present disclosure can apply feature identification techniques such as a fingerprint sensor to the social life, thus not only facilitating a client terminal (e.g., a user) to exchange personal information rapidly but also avoiding problems such as information loss or record error, thereby facilitating greatly the usage of the client terminal.

The server provided by embodiments of the present disclosure may be for example a computer, a tablet computer, a mobile phone having a touch screen and the like, the server and the method for acquiring information of a client terminal in the above embodiments are based on a same concept, any one of methods provided by the embodiments of the method for acquiring information of a client terminal can be implemented on the server, see the embodiments of the method for acquiring information of a client terminal for the specific implementation of the methods, and the details thereof are omitted herein.

It should be noted that with respect to the method for acquiring information of a client terminal according to embodiments of the present disclosure, those skilled in the art will appreciate that all or part of procedures to implement the method for acquiring information of a client terminal according to the embodiments of the present disclosure may be implemented by related hardwares under instructions of a computer program, the computer program is stored in a computer readable storage medium, such as stored in a storage of a terminal, and implemented by at least one processor in the terminal, and procedures as described in embodiments of the above respective methods may be included during the implementation. Wherein the aforementioned storage medium may be a magnetic disk, an optical disk, an ROM, an RAM and the like.

For the server according to embodiments of the present disclosure, all functional modules may be integrated into one processing chip, they may exist in the form of a respective module, and they may exist in the form of two or more modules being integrated into one module. The above integrated module may be implemented in the form of not only a hardware but also a software functional module. If the integrated module is implemented in the form of a software functional module and sold or used as an independent product, it may also be stored in a computer-readable storage medium, which may be for example an ROM, a magnetic disk, an optical disk or the like.

To sum up, though the present disclosure is disclosed as above based on preferable embodiments, the above preferable embodiments are not intended to limit the present disclosure, and various changes and retouches may be made by those skilled in the art without departing from the spirit and scope of the present disclosure, thus the scope of protection of the present disclosure is the scope defined by the claims.

1. A method for acquiring information of a client terminal, comprising:
acquiring in advance, by a server, fingerprint data of the client terminal and information of the client terminal corresponding to the fingerprint data of the client terminal, correlating the fingerprint data of the client terminal with the information of the client terminal and storing them in the server;
receiving, by the server, fingerprint data of the client terminal transmitted by a feature acquisition device, acquiring information of the client terminal corresponding to the fingerprint data of the client terminal according to the fingerprint data of the client terminal; and
transmitting, by the server, acquired information of the client terminal to the feature acquisition device.

2. The method according to claim 1, wherein the step of the correlating the fingerprint data of the client terminal with the information of the client terminal and storing them in the server comprises:
allocating, by the server, a client terminal identification to the fingerprint data of the client terminal after the fingerprint data of the client terminal is acquired; and
correlating, by the server, the fingerprint data of the client terminal, the client terminal identification with the information of the client terminal and storing them in the server.

3. The method according to claim 2, wherein the step of the acquiring information of the client terminal corresponding to the fingerprint data of the client terminal comprises:
matching, by the server, the client terminal identification corresponding to the fingerprint data of the client terminal according to the fingerprint data of the client terminal; and
matching, by the server, the information of the client terminal corresponding to the fingerprint data of the client terminal according to the matched client terminal identification.

4. A method for acquiring information of a client terminal, comprising:
receiving, by a server, a feature identification of the client terminal transmitted by a feature acquisition device;
acquiring, by the server, information of the client terminal corresponding to the feature identification of the client terminal according to the feature identification of the client terminal; and
transmitting, by the server, the acquired information of the client terminal to the feature acquisition device.

5. The method according to claim 4, further comprising:
before receiving the feature identification of the client terminal transmitted by the feature acquisition device, acquiring in advance, by the server, the feature identification of the client terminal and the information of the client terminal corresponding to the feature identification of the client terminal; and
correlating, by the server, the feature identification of the client terminal with the information of the client terminal and storing them in the server.

6. The method according to claim 5, wherein the step of correlating, by the server, the feature identification of the client terminal with the information of the client terminal and storing them in the server comprises:
allocating, by the server, a client terminal identification to the feature identification of the client terminal to the feature identification of the client terminal after the feature identification of the client terminal is acquired; and
correlating, by the server, the feature identification of the client terminal, the client terminal identification with the information of the client terminal and storing them in the server.

7. The method according to claim 6, wherein the step of acquiring, by the server, information of the client terminal corresponding to the feature identification of the client terminal according to the feature identification of the client terminal comprises:
matching, by the server, the client terminal identification corresponding to the feature identification of the client terminal according to the feature identification of the client terminal; and
matching, by the server, the information of the client terminal according to the matched client terminal identification.

8. The method according to claim 4, wherein the feature identification of the client terminal comprises at least one of the following: fingerprint data, palm print data, retina data, voice data and face feature data.

9. A server, comprising:
a feature identification reception module configured to receive a feature identification of a client terminal transmitted by a feature acquisition device;
a client terminal information acquisition module configured to acquire information of the client terminal corresponding to the feature identification of the client terminal according to the feature identification of the client terminal; and
a client terminal information transmission module configured to transmit the information of the client terminal acquired by the client terminal information acquisition module to the feature acquisition device.

10. The server according to claim 9, further comprising:
a feature identification acquisition module configured to acquire in advance the feature identification of the client terminal and the information of the client terminal corresponding to the feature identification of the client terminal;
a client terminal information correlation module configured to correlate the feature identification of the client terminal acquired by the feature identification acquisition module with the information of the client terminal corresponding to the feature identification of the client terminal; and
a storage module configured to store the correlated feature identification of the client terminal and information of the client terminal.

11. The server according to claim 10, wherein the client terminal information correlation module comprises:
a client terminal identification allocation module configured to allocate a client terminal identification corresponding to the feature identification of the client terminal to the feature identification of the client terminal; and
a client terminal identification correlation module configured to correlate the feature identification of the client terminal, the client terminal identification corresponding to the feature identification of the client terminal with the information of the client terminal.

12. The server according to claim 11, wherein the client terminal information acquisition module comprises:
a client terminal identification matching module configured to match the client terminal identification corresponding to the feature identification of the client terminal according to the feature identification of the client terminal; and
a client terminal information matching module configured to match the information of the client terminal according to the client terminal identification matched by the client terminal identification matching module.

13. The server according to claim 9, wherein the feature identification of the client terminal comprises at least one of the following: fingerprint data, palm print data, retina data, voice data and face feature data.

14. A computer-readable medium with processor-executable instructions stored therein, wherein the processor-executable instructions are configured to enable a processor to implement the following operations:
receiving a feature identification of the client terminal transmitted by a feature acquisition device;
acquiring information of the client terminal corresponding to the feature identification of the client terminal according to the feature identification of the client terminal; and
transmitting the acquired information of the client terminal to the feature acquisition device.

15. The computer-readable medium according to claim 14, wherein the processor-executable instruction stored in the storage medium is further configured to enable the processor to implement the following operations:
acquiring in advance the feature identification of the client terminal and the information of the client terminal corresponding to the feature identification of the client terminal; and
correlating the feature identification of the client terminal with the information of the client terminal and storing them.

16. The computer-readable medium according to claim 15, wherein the processor-executable instructions are further configured to enable the processor to implement the following operations:
allocating a client terminal identification corresponding to the feature identification of the client terminal to the feature identification of the client terminal after the feature identification of the client terminal is acquired; and
correlating the feature identification of the client terminal, the client terminal identification with the information of the client terminal and storing them.

17. The computer-readable medium according to claim 16, wherein the processor-executable instructions are further configured to enable the processor to implement the following operations:
matching the client terminal identification corresponding to the feature identification of the client terminal according to the feature identification of the client terminal; and
matching the information of the client terminal according to the matched client terminal identification.

18. The computer-readable medium according to claim 14, wherein the feature identification of the client terminal comprises at least one of the following: fingerprint data, palm print data, retina data, voice data and face feature data.
